(19) United States
(12) Patent Application Publication
(10) Pub. No.: US 2022/0312092 A1
(43) Pub. Date: Sep. 29, 2022

(54) Space saving means of combining high/mid frequency sound generation/diffraction and reflection in the mouth of a low frequency port

(71) Applicant: Raymond Lawrence Kelly, III, Dudley, MA (US)

(72) Inventor: Raymond Lawrence Kelly, III, Dudley, MA (US)

(21) Appl. No.: 17/248,235

(22) Filed: Mar. 24, 2021

(51) Int. Cl. H04R 1/02; H04R 1/04

(52) U.S. Cl. CPC H04R 1/023; H04R 1/04; H04R 1/026

(57) ABSTRACT

A loudspeaker cabinet design that increases dispersion and minimizes cabinet size by not only mounting mid and high frequency generators in the mouth of the port horn, but also placing diffractors and reflectors within the mouth of the port horn. Additionally grab handle cut-outs are placed at specific locations in the side walls to increase horizontal dispersion.

The inventive device creates greater vertical and horizontal dispersion characteristics from a smaller than previously possible cabinet, aiding particularly those who require frequent transport of loudspeakers.

### BACKGROUND OF THE INVENTION

For comparison of the new design vs. the current state of loudspeakers (especially where portability is a concern) it is easiest to look at guitar, bass guitar, keyboard, public-address loudspeakers and alike. Many designs are of extremely narrow sound dispersion. It's known mid and high frequencies (shorter wavelength frequencies) emanating from a large diameter driver are exceptionally directional. Cabinets using 10″ or 12″ drivers suffer from ‘laser-beam’ like directivity at higher frequencies, creating small hotspots of sound in an audience with very little sound delivered in horizontal and vertical planes off-axis from the driver. sin Ø=wavelength*m verifies that high frequency sound emanating from a large driver is extremely directional.

A common solution to this problem is to employee other devices with wider dispersion like horns, reflectors, etc. . . . to broaden overall dispersion. The issue for portability is that these devices increase the required size of the cabinet.

But because different frequencies of sound neither combine constructively nor destructively while occupying the same space it is possible to use the same specified space in the cabinet to perform several tasks including impedance matching of low frequencies to the surrounding environment as well as reflection and diffraction of mid and high frequencies to the surrounding environment.

The invention outlined takes advantage of this phenomenon by placing the mid and high frequency drivers in the mouth of the port horn as well as adding reflectors and diffractors thus effectively using the volume of the port horn not only for low frequency reinforcement but also mid and high frequency generation and dispersion.

### DESCRIPTION OF DRAWINGS

FIG. 1 Depicts the invention as described. Traditional “ported” cabinet designs employee a low frequency driver (G), in a cabinet that adds a tuned port (A). Some ports use flares at the ends of the port to aid in pressure change (an acoustic transformer). That acoustic transformer is the “port mouth” (B). The difference in this design is that the mid/high transducer(s) (F), the conical reflector (C), the port mouth (B), and any diffractors desired (laid flat on top of the driver, not visible in drawing) are all contained within the space labelled (H).

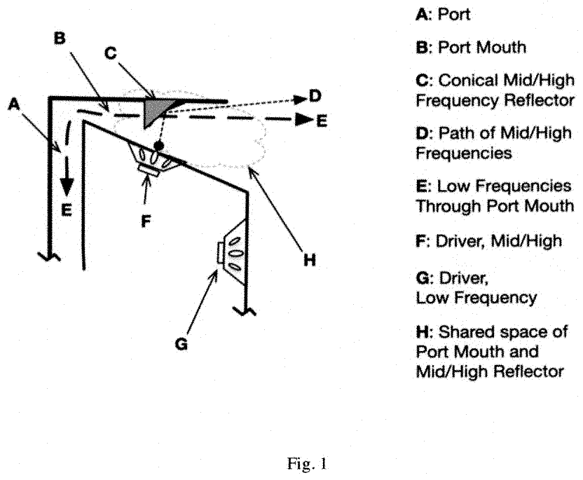

It should be noted that by mounting the mid/high driver(s) (F) on the slanted plane of the port mouth, vertical dispersion is also dramatically improved in a desired direction. (Grab handle cut-outs not shown for clarity.)

FIG. 2 Shows the overall cabinet design on the left, and the area where the port mouth allows all frequencies to exit on the far right. (Grab handle cut-outs not shown for clarity.)

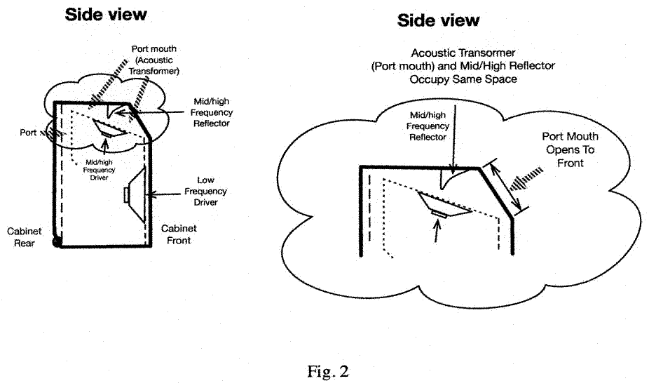

FIG. 3 Specifically depicts the path of mid and high frequencies (dotted lines A) originating at the driver (B), then reflecting off the conical reflector (C) and exiting through the grab-handle cut-outs on each side of the cabinet (D) to improve side dispersion. Grab-handle cutouts (D) are specifically located to increase dispersion.

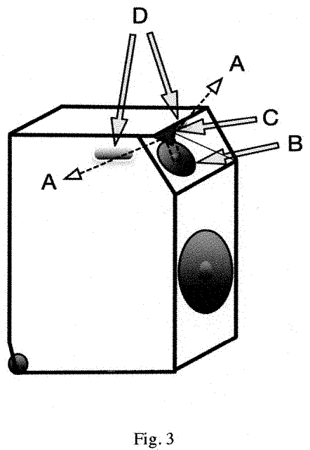

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and described in the specification are intended to be encompassed by the present invention.

Therefore, the foregoing is considered as illustrative only of the principles of the invention further, since numerous modifications and changes will readily occur to those skilled in the art, it is not desired to limit the invention to the exact construction and operation shown and described, and accordingly, all suitable modifications and equivalents maybe resorted to, falling within the scope of the invention.

1. A loudspeaker cabinet design which minimizes size and increases dispersion by combining transducers, reflectors, and diffractors all within the port mouth.
The mid/high frequency driver(s) are mounted on the upward angled portion of the port mouth specifically to improve vertical dispersion.
Grab handle cut-outs are specifically and intentionally placed to increase side dispersion.
